(19) United States
(12) Patent Application Publication
(10) Pub. No.: US 2013/0316218 A1
(43) Pub. Date: Nov. 28, 2013

(54) ELECTROCHEMICAL ENERGY ACCUMULATOR

(71) Applicants: Ulf Dahlmann, Gau-Odernheim (DE); Andreas Roters, Mainz (DE); Dieter Goedeke, Bad Soden (DE); Frank-Thomas Lentes, Bingen (DE); Joern Besinger, Ludwigshafen (DE); Olaf Claussen, Undenheim (DE); Christian Kunert, Mainz-Kastel (DE); Ulrich Peuchert, Bodenheim (DE); Wolfgang Schmidbauer, Mainz (DE); Wolfram Beier, Essenheim (DE); Sabine Pichler-Wilhelm, Landshut (DE)

(72) Inventors: Ulf Dahlmann, Gau-Odernheim (DE); Andreas Roters, Mainz (DE); Dieter Goedeke, Bad Soden (DE); Frank-Thomas Lentes, Bingen (DE); Joern Besinger, Ludwigshafen (DE); Olaf Claussen, Undenheim (DE); Christian Kunert, Mainz-Kastel (DE); Ulrich Peuchert, Bodenheim (DE); Wolfgang Schmidbauer, Mainz (DE); Wolfram Beier, Essenheim (DE); Sabine Pichler-Wilhelm, Landshut (DE)

(73) Assignee: Schott AG, Mainz (DE)

(21) Appl. No.: 13/877,964

(22) PCT Filed: Sep. 29, 2011
(86) PCT No.: PCT/EP2011/067013

§ 371 Date: May 20, 2013

(30) Foreign Application Priority Data
Oct. 7, 2010 (DE) 10-2010-048-919.0
Oct. 7, 2010 (DE) 10-2010-048-922.0

(51) Int. Cl. H01M 2/16

(52) U.S. Cl. CPC H01M 2/16
USPC 429/144; 429/246; 429/188; 429/199; 429/247

(57) ABSTRACT

A glass-based material is disclosed, which is suitable for the production of a separator for an electrochemical energy accumulator, in particular for a lithium ion accumulator, wherein the glass-based material comprises at least the following constituents (in wt.-% based on oxide): SiO₂+F+P₂O₅ 20-95; Al₂O₃ 0.5-30, wherein the density is less than 3.7 g/cm³.

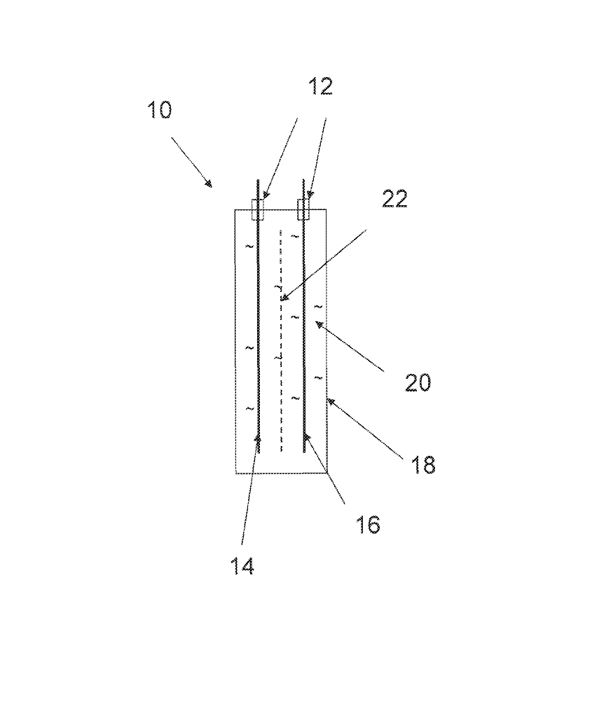

### CROSS REFERENCE TO RELATED APPLICATIONS

This application is a continuation of international patent application PCT/EP2011/067013, filed on Sep. 29, 2011 designating the U.S.A., which international patent application has been published in German language and claims priority from German patent applications 10 2010 048 922.0 and 10 2010 048 919.0, both filed on Oct. 7, 2010. The entire content of each these priority applications is incorporated herein by reference.

### BACKGROUND OF THE INVENTION

The invention relates to an electrochemical energy accumulator and to the use of a glass-based material for the production of a separator for an electrochemical energy accumulator, in particular for a rechargeable lithium ion accumulator.

Future applications of lithium ion accumulators, for example in motor vehicles, static applications, e-bikes, etc., require an improvement of lithium ion accumulators (also abbreviated to LIB cells) in terms of safety, cost and lifetime. Issues of weight also need to be resolved with a view to increasing the specific energy density, or power density.

In this context, one component is of great importance: the so-called separator. At present, it is usually a drawn porous membrane of polyethylene (PE), polypropylene (PP) or a mixture thereof. Contemporary loading temperatures are at 160° C., corresponding to the melting point of PP. Nonwovens made from PET fibers are stable up to 200° C., and sometimes even above this. Polyamides and polyimides are also used in the scope of polymer membranes, for example as a coating.

There is a need for thermally more stable separators, which ensure physical separation of the electrodes even at higher temperatures, arising as a result of operation or in the event of damage.

In the context of this application, a separator is intended to mean any means which is suitable for separating the two electrodes from one another. What is important in this case is physical separation of the electrodes with simultaneous good permeability for the electrolyte. The separator may, in the conventional way, be for instance a component in the form of a membrane, which consists for example of PE, PP or a mixture thereof, and which is coated in a suitable way with a chemically and electrochemically stable material by which sufficient thermal stability is ensured, together with an Li ion permeability which is as constant as possible. Other embodiments of a separator may, however, also be envisioned, for example with a suitable material being applied, in addition or as an alternative to the aforementioned separator membrane, directly on one or both electrodes. According to another separator embodiment, a suitable material is powdered or taken up in the electrolyte in another way, in order to ensure the function of separation between the two electrodes. All these possibilities, as well as others, for spatial and electrically insulating separation of the electrodes are to be understood by the term “separator” in the context of this application.

The separator must furthermore be lightweight and have a lithium permeability which is unchanged, and ideally improved, in relation to the prior art. The separator must be chemically inert, i.e. capable of withstanding the harsh conditions of the liquid electrolyte environment. The long term stability required for this also involves no harmful constituents being released into the battery cells during normal operation. The separator should furthermore be producible as economically as possible.

There is currently still no satisfactory solution to the problem of simultaneously thermally stable, lightweight, lithium ion-permeable and long term stable separation of two electrodes. In particular, there is to date a lack of a satisfactory solution for large-format LIB cells, i.e. LIB cells with a high storage capacity.

Pure polymer-based separators are limited in terms of their thermal stability to temperatures of from 200° C. to at most 250° C.

In the prior art, chemically simple inorganic crystalline particles are sometimes used as thermally stable coatings on separators in membrane form. In this case, crystalline Al₂O₃, crystalline SiO₂ and crystalline ZrO₂ are used in particular.

DE 102 38 944 A1 and DE 102 08 277 A1 describe the coating, or infiltration, of polymer nonwovens with particles, inter alia particles of thermally very stable Al₂O₃. The mass fractions are >50%, i.e. the particles make up the main proportion of the overall surface density. Crystalline Al₂O₃, however, has a very high density and therefore makes the separator very heavy.

EP 2 153 990 A1 discloses the coating of a multilayer porous membrane consisting of polypropylene and one or more polyolefins with Al₂O₃.

According to US 2009/0087728 A1 and according to WO 2010/029994 A1, separators coated with inorganic materials, such as SiO₂, Al₂O₃ and TiO₂, are likewise used. Although SiO₂ has a low density, on the other hand it is not sufficiently chemically stable. Conversely, the other materials which are sometimes deposited on the electrodes are either significantly heavier or not sufficiently chemically stable.

JP (A) 2005-11614 discloses the use of glass in conjunction with a polymeric separator. The silicon content of the glass should be between 40 and 90 wt.-%, and Na₂O, K₂O, CaO, MgO, BaO, PbO, B₂O₃, Al₂O₃ or ZrO₂ may also be contained. Supposedly, chemical capture of Li by compound formation in the event of damage is intended to be made possible with the aid of the glass. In this case, however, there is a lack of sufficient disclosure. Not even one suitable glass composition is disclosed. To this extent, these comments must be regarded as purely speculative. In particular, the chemical stability property of a glass, which is required for the application, can only be assessed with the aid of a specific glass composition.

WO 2009/103537 A1 discloses the coating of nonwovens, fabrics and membranes with inorganic particles of metal oxides, metal hydroxides, nitrides, carbonitrides, carbooxynitrides, borates, sulfates, carbonates, glass particles, silicates, aluminum oxides, silicon oxides, zeolites, titanates and perovskites. These are also meant to be usable as separators in batteries. While a wide range of organic particles is furthermore disclosed, the suitability of the various inorganic particles for use in an LIB separator remains uncertain.

EP 1 667 254 A1 describes the use of ceramic material consisting of SiO₂, Al₂O₃, ZrO₂ or TiO₂ for the production of separators. One embodiment is in this case the direct deposition of, for example, ZrO₂ on the electrodes.

DE 19839217 A1 places particular importance on the integration of crystalline Li—Al—Ti phosphates to form self-supporting polymer membranes. Such phases also have a high density and—when introduced in sizeable amounts—increase the overall weight of the component and therefore of the overall cell.

### SUMMARY OF THE INVENTION

In view of this, it is a first object of the invention to disclose an improved separator for an electrochemical energy accumulator, in particular a lithium ion accumulator.

It is a second object of the invention to disclose an improved separator for an electrochemical energy accumulator having a low density and a high chemical stability.

It is a third object of the invention to disclose an improved separator for an electrochemical energy accumulator having a lithium permeability which is unchanged, and ideally improved, in relation to the prior art.

It is a forth object of the invention to disclose an improved separator for an electrochemical energy accumulator which can be produced in large quantities in an economical manner.

It is a fifth object of the invention to disclose an improved electrochemical energy accumulator.

It is a sixth object of the invention to disclose an improved method of making an electrochemical energy accumulator.

According to one aspect of the invention these and other objects are achieved by an electrochemical energy accumulator, comprising: a housing; two electrodes arranged within said housing and being electrically accessible from outside; a liquid electrolyte enclosed within said housing; and a separator arranged within said electrolyte for separating said electrodes from one another; wherein the separator comprises a glass-based material containing at least the following constituents (in wt.-% based on oxide):

| | |
|---|---|
| SiO₂ + F + P₂O₅ | 20-95 |
| Al₂O₃ | 0.5-30; |
| BaO | >20 |

wherein the glass-based material has a density of less than 3.7 g/cm³.

According to another aspect of the invention the glass-based material is essentially free of bismuth and, apart from random impurities, does not contain any germanium and titanium.

According to a further aspect of the invention these and other objects of the invention are achieved by a separator for use in an electrochemical energy accumulator, said separator having a density which is less than 3.7 g/cm³ and comprising a glass-based material having at least the following constituents (in wt.-% based on oxide):

| | |
|---|---|
| SiO₂ + F + P₂O₅ | 20-95 |
| Al₂O₃ | 0.5-30 |
| TiO₂ | 0-5; |

wherein the glass-based material is essentially free of bismuth and has a density of less than 3.7 g/cm³.

A glass-based material is in this case intended to mean either a glass or a glass ceramic, i.e. a glass comprising crystalline components, which is fully or partially crystallized in the course of the production of the glass or which is converted into a glass ceramic, through precipitation of crystalline components, by controlled heat treatment after the production of the glass by melt technology.

The materials used according to the invention for producing a separator are distinguished, in particular, by a low density and by good stability with respect to the chemically aggressive environment of the liquid electrolyte.

Owing to their flexibly adjustable chemistry, further advantageous properties may clearly also be found. For instance, when introduced as powder, the materials according to the invention promote the Li conductivity and are highly wettable, so that they contribute to better Li permeability through the separator.

Although the materials according to the invention are suitable in principle for various types of accumulator, the invention places particular importance on lithium ion accumulators, in particular based on liquid electrolyte.

The materials used according to the invention are distinguished, in particular, by a low density. It is preferably less than 3.7 g/cm³, preferably less than 3.2 g/cm³, more preferably less than 3.0 g/cm³, particularly preferably less than or equal to 2.8 g/cm³.

Low-density glasses or glass ceramics allow the separator to be made lighter with the same application density or application volume, for example in the case of coating a carrier membrane with Al₂O₃. Under the constraint of conventional specific separator quantities, for example 0.07 m²/Ah and, by way of example, a ⅔ mass fraction of the coating on the separator, a mass saving of more than 20 g is achieved when using, for example, a glass or a glass ceramic having a density of 2.8 g/cm³ in the case of a 60 Ah cell. Such mass savings are significant for the automobile manufacturer and are useful in the overall weight configuration.

SnO₂, As₂O₃, Sb₂O₃, sulfur, CeO₂, etc. may be used as conventional fining agents. In particular when polyvalent fining agents are necessary, the proportion thereof should be kept as small as possible, ideally below 500 ppm, for reasons of electrochemical stability.

In principle, fining agents may preferably even be fully obviated, if the glass is tailored to the application, i.e. produced as fine powder, and the demand for freedom from bubbles is not great. Since fining agents are liable to cause uncontrolled redox reactions in an accumulator owing to their polyvalency, they should be avoided as far as possible.

In this case, the glass-based material contains no fining agents apart from random impurities. In particular, the fining agent content is <500 ppm or even <200 ppm, particularly preferably <100 ppm.

According to another embodiment of the invention, the glass-based material contains at least the following constituents (in wt.-% based on oxide):

| | |
|---|---|
| SiO₂ | 50-95 |
| Al₂O₃ | 1-30 |
| B₂O₃ | 0-20 |
| Li₂O | 0-20 |
| R₂O | <15% |
| RO | 0-40 |
| MgO | 0-7 |
| CaO | 0-5 |
| BaO | 0-30 |
| SrO | 0-25 |
| ZrO₂ | 0-15 |
| ZnO | 0-5 |
| P₂O₅ | 0-10 |
| F | 0-2 |
| TiO₂ | 0-5 |

fining agents in conventional amounts of up to 2%, where R₂O is the total sodium oxide and potassium oxide content, and where RO is the total content of oxides of the type MgO, CaO, BaO, SrO, ZnO.

According to another embodiment of the invention, the total sodium oxide and potassium oxide content is at most 12 wt.-%, preferably at most 5 wt.-%, or is less than 1 wt.-% or even zero, apart from random impurities.

According to another embodiment of the invention, the sodium oxide content is at most 5 wt.-%, preferably at most 1 wt.-%, particularly preferably at most 0.5 wt.-%. Preferably—apart from random impurities—the material is free of sodium oxide.

According to another embodiment of the invention, the aluminum oxide content is at least 1 wt.-%, in particular at least 3 wt.-%, preferably at least 9 wt.-%.

According to another embodiment of the invention, the B₂O₃ content is at least 3 wt.-%, preferably at least 10 wt.-%.

According to another embodiment of the invention, the ZrO₂ content is at least 0.5 wt.-%, preferably at least 1 wt.-%. On the other hand, a particularly low ZrO₂ content has advantages in relation to the density.

According to another embodiment of the invention, the ZnO content is at least 0.5 wt.-%, preferably at least 1 wt.-%.

According to another embodiment of the invention, the BaO content is at least 5 wt.-%, preferably at least 10 wt.-%, more preferably at least 20 wt.-%.

According to another embodiment of the invention, the RO content is at least 2, preferably from 2 to 7 wt.-%, where RO is the total content of oxides of the type MgO, CaO, BaO, SrO, ZnO.

According to another embodiment of the invention, the SiO₂ content is from 50 to 90 wt.-%, preferably from 55-80 wt.-%, particularly preferably from 60 to 70 wt.-%.

According to another embodiment of the invention, the material used according to the invention is formed as a glass ceramic, preferably with precipitates of high quartz mixed crystals, keatite, eucryptite and/or cordierite crystals, preferably with a total content of at least 50 vol.-%.

According to a first variant, the glass or glass ceramics used according to the invention for the production of separators are low in Na and K, preferably Na- and K-free. In this case, 2 glass ranges arise in particular, one constituting a silicate glass having an Al₂O₃ content of at least 1 wt.-% and the other constituting a phosphate/fluoride glass having a P₂O₅ content of at least 5 wt.-% and a fluorine content of at least 20 wt.-%, or a phosphate glass having a P₂O₅ content of at least 50 wt.-%. The glass compositions used according to the invention (synthesis values) preferably consist for instance of the following components:

| | |
|---|---|
| SiO₂ | 50-95 |
| Al₂O₃ | 1-30 |
| B₂O₃ | 0-15 |
| Li₂O | 0-15 |
| R₂O (R = Na, K) | <5% |
| sum RO | 0.5-40 |
| MgO | 0-7 |
| CaO | 0-5 |
| BaO | 0-30 |
| SrO | 0-25 |
| ZrO₂ | 0-15 |
| ZnO | 0-5 |
| Ta₂O₅ | 0-5 |
| P₂O₅ | 0-10 |
| F | 0-2 |
| TiO₂ | 0-5, |

where RO is the total content of MgO, CaO, BaO, SrO, and ZnO.

The following range is further preferred:

| | |
|---|---|
| SiO₂ | 55-80 |
| Al₂O₃ | 5-15 |
| B₂O₃ | 5-15 |
| P₂O₅ | 0-2 |
| Li₂O | 0-7 |
| R₂O (R = Na, K) | <1% |
| BaO | 20-30 |
| MgO | 0-5 |
| ZnO, ZrO₂ | each 0-2. |

According to another embodiment of the invention, the following range is particularly preferred:

| | |
|---|---|
| SiO₂ | 60-70 |
| Al₂O₃ | 15-30 |
| B₂O₃ | 0-5 |
| P₂O₅ | 0-5 |
| Li₂O | 0-10 |
| R₂O (R = Na, K) | <1% |
| sum RO | 2-7 |
| ZrO₂ | 0-15 |
| ZnO | 0-5. |

For the alternative range based on phosphate glass, the glass-based material according to the invention has at least the following constituents (synthesis values, in wt.-% based on oxide):

| | |
|---|---|
| SiO₂ | 0-10 |
| Al₂O₃ | 0.5-20 |
| B₂O₃ | 0-15 |
| R₂O | 0-25 |
| Li₂O | 0-20 |
| MgO | 0-10 |
| CaO | 0-10 |
| BaO | 0-25 |
| SrO | 0-25 |
| ZnO | 0-10 |
| P₂O₅ | >5-80 |
| F | 0-40 |

where R₂O is the total alkali metal oxide content.

According to another embodiment of the invention, the glass-based material contains at least the following constituents (synthesis values, in wt.-% based on oxide):

| | |
|---|---|
| SiO₂ | 0-10 |
| Al₂O₃ | 0.5-20 |
| B₂O₃ | 0-7 |
| Li₂O | 0-20 |
| R₂O | <15 |
| RO | 0-22 |
| MgO | 0-7 |
| CaO | 0-10 |
| BaO | 0-20 |
| ZnO | 0-10 |
| P₂O₅ | 60-85 |
| F | 0-2 |

where R₂O is the total sodium oxide and potassium oxide content, and where RO is the total MgO, CaO, BaO, SrO and ZnO content.

Another preferred range comprises materials having essentially the following components:

| | |
|---|---|
| SiO₂ | 0-10 |
| Al₂O₃ | 1-20 |
| B₂O₃ | 0-7 |
| P₂O₅ | 60-85 |
| Li₂O | 0-17 |
| R₂O | <5 |
| sum RO | 2-30 |
| with | |
| MgO | 0-7 |
| CaO | 0-10 |
| BaO | 0-20 |
| ZnO | 0-7 |
| F | 0-5 |
| ZrO₂ | 0-7 |

fining agents in conventional amounts,

where R₂O is the total Na₂O and K₂O content, and where RO is the total MgO, CaO, BaO, SrO and ZnO content.

Another preferred range comprises materials having essentially the following components:

| | |
|---|---|
| P₂O₅ | 65-80 |
| Al₂O₃ | 5-12 |
| B₂O₃ | 3-5 |
| Li₂O | 0-7 |
| R₂O | <5 |
| sum RO | 0-20 |
| with | |
| MgO | 0-7 |
| CaO | 0-10 |
| BaO | 0-20 |
| ZnO | 0-2 |
| F | 0-2 |
| ZrO₂ | 0-4 |

fining agents in conventional amounts,

where R₂O is the total Na₂O and K₂O content, and where RO is the total MgO, CaO, BaO, SrO and ZnO content.

In this case, there are furthermore the following preferred embodiments in particular:

The Al₂O₃ content is preferably at least 1 wt.-%, preferably at least 3 wt.-%, more preferably at least 9 wt.-%.

According to another embodiment of the invention, the P₂O₅ content is at least 10 wt.-%, preferably at least 50 wt.-%, more preferably at least 60 wt.-%, in particular at least 65 wt.-%.

According to another embodiment of the invention, the fluorine content is at least 5 wt.-%, preferably at least 10 wt.-%, more preferably at least 20 wt.-%.

According to another embodiment of the invention, the alkali metal oxide content is less than 1 wt.-%, and preferably, apart from random impurities, no alkali metal oxides are contained.

According to another embodiment of the invention, the SiO₂ content is at most 5 wt.-%, preferably at most 2 wt.-%, and more preferably the material is free of SiO₂ apart from random impurities.

According to another embodiment of the invention, the barium oxide content is at least 1 wt.-%, preferably at least 5 wt.-%.

According to another embodiment of the invention, the magnesium oxide content is at least 0.1 wt.-%, preferably at least 0.5 wt.-%, more preferably at least 2 wt.-%.

According to another embodiment of the invention, the calcium oxide content is at least 0.5 wt.-%, preferably at least 2 wt.-%.

According to another embodiment of the invention, the zinc oxide content is at least 0.5 wt.-%, preferably at least 2, more preferably at least 5 wt.-%.

According to another embodiment of the invention, the lithium oxide content is at least 0.5 wt.-%, preferably at least 2 wt.-%.

According to another embodiment of the invention, the potassium oxide content is at least 0.5 wt.-%, preferably at least 1 wt.-%, more preferably at least 5 wt.-%.

In both variants, both in the case of materials based on silicate glass and in the case of materials based on phosphate glass, in a preferred refinement of the invention, apart from random impurities the materials are free of titanium, the titanium content being in particular <500 ppm, preferably <100 ppm.

Titanium is redox-unstable on the anode side, and should therefore be avoided as far as possible.

Preferably, apart from random impurities, the materials are also free of germanium, the germanium content being in particular <500 ppm, preferably <100 ppm. Owing to the high price of germanium, this should be avoided as far as possible.

Preferably, the glass-based material is used as a filler, preferably in powder form, in a liquid-electrolyte lithium ion accumulator.

According to another alternative, the glass-based material is applied as a coating onto the surface of a separator, and in particular is applied on the surface of a polymer-based separator, or is used for the infiltration of a polymer-based separator.

According to another variant of the invention, the glass-based material is compounded with polymers to form a self-supporting separator.

According to another variant of the invention, the glass-based material is used for the coating of an electrode.

The materials used according to the invention have a sufficiently high chemical stability.

In order to determine the chemical stability with respect to the electrolyte of an LIB battery, a time-dependent measurement of the lithium ion conduction of an EC/DMC/LiPF6 electrolyte is employed, essentially according to Baucke et al. (“Genaue Leitfähigkeitsmesszelle für Glas- and Salzschmelzen” [Accurate conductivity measurement cell for glass melts and salt melts], Glastechn. Ber. 1989, 62 [4], 122-126).

According thereto, the relative change in the electrical conductivity in relation to the measured starting value (initial value) after 3 days is not more than 100%, preferably not more than 50%, more preferably not more than 10%, particularly preferably not more than 5%.

### BRIEF DESCRIPTION OF THE DRAWING

The invention will be explained in more detail below with the aid of exemplary embodiments, partially in connection with the drawing. As its single FIGURE, the drawing shows an LIB cell in a schematic representation.

### DESCRIPTION OF PREFERRED EMBODIMENTS

The FIGURE schematically represents an LIB cell, which is denoted overall by 10. The LIB cell 10 has a housing 18 with two electrode feed-throughs 12. The electrode feed-throughs are respectively connected to a first electrode 14, which consists of Cu and is coated with anode material, and to a second electrode 16, which may be an Al conductor foil coated with cathode material. Between the electrodes, there is a separator 22, which may be a polymer film which is coated with glass particles. The interior of the housing 18 is filled with electrolyte liquid 20.

### EXAMPLES

### 1. Composition of the Materials

Table 1 presents the data of various conventional separator materials as comparative examples VB 1 to VB 3, a potential material furthermore being presented as comparative example VB 4, although its density is too high and it is furthermore not sufficiently chemically stable.

Table 1 furthermore summarizes various glasses or glass ceramics based on silicate, which are used according to the invention, under AB1 to AB5. Table 2 shows materials according to the invention which are based on phosphate or fluorophosphate (Exemplary Embodiments AB6 to AB10). The data in the tables are setpoint synthesis values; according to production, certain deviations may arise in the actual composition.

### 2. Production of the Materials

For SiO₂ as comparative examples, two different qualities of raw materials were used. VB 2A is a silica glass, i.e. essentially 100% SiO₂ with certain impurities. It is converted into powder with grains of d50˜10 μm. The comparative powder VB 2B is a material from Quarztechnische Werkstätten (Langenlohnsheim) with 0.12 wt.-% WO₃ impurity. It has a grain size of d50˜10 μm, and production was carried out using a jaw crusher, ball mill (roller apparatus) and an attritor.

The powder AB2 was measured with grain d50=0.4 μm. Production was carried out by:
melting in a Pt/Ir1 crucible at temperatures >1550° C.
shaping and quenching the melt to form ribbons
dry grinding for 24 hours in a drum mill with Al₂O₃ grinding bodies
wet grinding for 10 hours in water
spray drying in a drying column

The other exemplary glasses were produced essentially similarly to AB2. Differences relate in particular to melting in a tank clad with refractory blocks in the case of AB1, although the other glasses may also be melted in a tank clad with refractory blocks if required.

The exemplary embodiments presented have both density and conductivity values within the ranges specified according to the invention. In contrast thereto, comparative materials SiO₂ and Al₂O₂ are either too heavy or not chemically stable.

AB2 exhibits better stability compared with SiO₂, despite a smaller grain size (i.e. despite a larger reactive surface area). In relation to Al₂O₃, the glass has lower density. It furthermore has a higher normalized electrolyte conductivity than Al₂O₃.

AB4 is also lighter than Al₂O₃, and can be stored without problems in the battery electrolyte for several days. With respect to the electrolyte conductivity, with 9.3 mS/cm the material has a higher value than VB 3 and is furthermore distinguished by an outstanding relative aging value of <1%.

### 3. Determination of the Chemical Stability

For this measurement, the materials used according to the invention are first converted into powder form. In this case, an average particle size with a d50˜10 μm is advantageous. Finer powders down to a few 100 nm may, however, also be used for the measurements described below.

The chemical stabilities can be determined electrochemically by time-dependent measurement of the lithium ion conduction of an EC/DMC/LiPF₆ electrolyte. This is determined by means of a setup similar to that described in F. G. K. Baucke, J. Braun, G. Röth (in Genaue Leitfähigkeitsmesszelle für Glas- and Salzschmelzen, Glastechn. Ber. 1989, 62 [4], 122-126). In this case, the measurement cell is primarily adapted in terms of geometry to the present problem (diameter: 16 mm, height: 10-20 mm). It consists of 2 electrodes (a lower Pt disk and an upper Pt cross). A weighed and dried (400° C. vacuum) amount of glass powder (d50=10 μm or finer, 3-8 g) is introduced between the two electrodes, and is filled up with a measured amount of liquid electrolyte (1-3 ml, LP30 mixture of ethylene carbonate with dimethyl carbonate in the ratio 1:1 with a 1 molar solution of LiPF₆, Merck), until the point at which the mass is just slurried. The distance between the electrodes is then measured. By means of impedance measurement (PSIMETRICQ PSM1700), the ohmic impedance of the cell with a phase angle equal to zero is determined, and the conductivity normalized with respect to the electrolyte volume can then be calculated using the known geometry.

The test lasts from several days to several weeks, with a measurement being carried out repeatedly. As a measure of the chemical resistance, the relative change in the electrical conductivity in relation to a measured starting value (initial value) is used.

The stabilities established by means of conductivity measurements can be confirmed by chemical tests on powders or plates.

### 4. Increase in the Electrolyte Conductivity

For operation of the accumulator with the least possible resistance, the reduction in the conductivity of the liquid electrolyte which generally occurs when passing through the separator must be minimized. In other words, the permeability of the separator for Li must be kept high.

Typical free conductivities for the standard electrolyte, consisting of ethylene carbonate and dimethyl carbonate in the ratio 1:1 with the conductive salt LiPF₆ in 1 molar solution, are about 10 mS/cm. If this conductivity can be at least maintained, and ideally increased, the system gains several advantages. By reducing the internal resistances in the battery, on the one hand the thermal economy is relaxed and the lifetime (cyclability) of the battery is significantly increased. On the other hand, with a high conductivity of the battery, its power density is also increased and the load of the battery can draw more current from the same battery in the same period of time. For use in an automobile battery, this would equate to the possibility of a higher acceleration.

As the test method, the test already described above is used. Comparative and embodiment data are the conductivities after one day of aging. In relation to the aforementioned test, the materials used according to the invention have the following properties:

When changing from Al₂O₃ to glass, there is an increase in the conductivity of the electrolyte powder mixture of about 10% (AB4 or AB5), preferably >25%, particularly preferably >40% (AB3). Exemplary embodiments AB6 to AB9 show no increase in the conductivities, but instead they have an excellent stability in the battery electrolyte.

### 5. Wettability

Good wettability, or impregnation, of the separator with liquid electrolyte is advantageous in two regards: on the one hand, the production process is simplified in the sense that when liquid electrolyte is introduced (usually under reduced pressure) the separator region is reliably flushed fully and rapidly. On the other hand, productivity advantages are obtained: the defect rate when first charging and discharging (forming) is minimized since the cells are completely impregnated. Inhomogeneities in the ion through-flow, or the ion current density, due to inhomogeneities in the impregnation state of the cells are minimized.

### 6. Integration of the Separator Materials in an Accumulator

In order to produce a lithium ion accumulator, a positive electrode and a negative electrode must be integrated into a housing, a separator for separating the two electrodes from one another must be integrated and the cavity must be impregnated with the electrolyte. The individual steps are explained in brief below.

### 7. Production of Glass Powders and Slurries

First, the glass is melted, cooled, shaped while hot into a suitable geometry which is easy to separate (ribbons, fibers, balls) and rapidly cooled.

The glass is converted into powder by grinding and optionally subsequent drying (freeze drying, spray drying). Alternatively, the suspension formed during the wet grinding process may subsequently also be used directly.

As an alternative, fine amorphous glass powder may also be produced by means of a sol-gel method. To this end, a sol is produced from the alkoxides or similar compounds, which like alkoxides are readily capable of entering into crosslinking reactions by hydrolysis and condensation reactions, of the corresponding elements.

The resulting colloidal solution is treated by means of suitable measures, for example pH adjustment or addition of water, in order to induce gelling of the sol.

Alternatively, the sol may also be subjected to spray drying.

The solid formed in this way, which consists of particles, may subsequently be subjected to a calcining reaction in order to remove possible organic impurities.

In this way, nanoparticles of the corresponding material are also often obtained.

Small glass particles may also be produced by melting finely ground raw materials in flight, for example by applying a plasma.

Exemplary powder properties are:

| | | | |
|---|---|---|---|
| d50 [μm] | <1.5 | preferably <1 | more preferably <0.4 |
| d99 [μm] | <5 | preferably <4 | more preferably <3 |
| SSA [m²/g] | >3 | preferably >5 | more preferably >10. |

Alternative powder properties are:

| | | | |
|---|---|---|---|
| d50 [μm] | 0.2-5 | preferably 0.3-2.5 | particularly preferably 0.3-1.8 |
| d99 [μm] | 0.5-10 | preferably <3.5. | |

The powder specifications mentioned above may vary according to integration into an assembly, manufacturer or subsequent processor.

The powder data were determined by laser scattering measurements on the previously dispersed powders or suspensions (CILAS 1064 wet).

The method steps may be selected in such a way that bimodal powder characteristics are deliberately achieved. As an alternative, the operation may also be carried out with mixtures of glasses, or glass ceramics, having different grain size distributions. It is also possible to mix the glass with ceramic particles such as Al2O3, SiO2 (quartz), BaTiO3, MgO, TiO2, ZrO2 or other simple oxides.

By suitable selection of the production process, different grain shapes and contours may deliberately be set. The shapes may be fibrous, columnar, round, oval, angled, edged (primary grain), dumbbell-shaped, pyramidal, as platelets or flakes. The grains may be in the form of primary grain or agglomerated. The particles may be edged or flattened, or rounded, on the surface.

A grain shape, or geometry, with an aspect ratio of about 0.1 (ratio of short/long side) and sharp-edged grains is preferred. This gives stable interengagement of the grains in a particle packing structure which is nevertheless quite open.

### 8. Integration of the Particles as a Separator

What is crucial for the separation function is physical separation of the electrodes together with good permeability for the electrolyte.

This, for example, leads to four forms of integration of the particles into the cell assembly or component assembly as a separator:

a) Compounding of the Glass Particles with Polymer to form a Self-Supporting Membrane.

To this end, the particles in intimate contact with organic polymers, optionally with the use of swelling agents or solvents, binders and optionally plasticizers, are rolled as a compound in paste form into a self-supporting form, or cast or spread onto a support film. In detail, the following may be used as polymers: crosslinkable resin systems in liquid or paste form, for example resins of crosslinkable addition polymers or condensation resins, crosslinkable polyolefins or polyesters, curable epoxy resins, crosslinkable polycarbonates, polystyrene, polyurethane or polyvinylidene fluoride (PVDF), polysaccharides, thermoplastics or thermoelastomers. They may be used as a finished polymer, polymer precursors or prepolymers, optionally also with the use of a swelling agent suitable for the aforementioned polymers. For better adjustment of the mechanical flexibility, a plasticizer (softener) may be used. This may be chemically removed by dissolving after processing of the membrane. As a possible embodiment, one or more of the glasses mentioned is stirred into PVDF-HFP, dibutylphthalate and acetone. The compound in paste form is then, for example, applied onto an auxiliary substrate, and cured by UV or heat treatment or by introduction into chemical reagents.

### b) Coating or Infiltration of Polymeric Separator Carriers

In this case, the glass particles are applied by suitable particle deposition processes onto membranes or nonwovens. Porous carriers may in this case be: dry-drawn membranes (for example from Celgard) or wet-extracted membranes (for example from Tonen). These generally consist of PE, PP or PE/PP mixtures, or multilayer membranes produced therefrom. As an alternative, so-called nonwovens of polyolefins or PET may also be used. In the latter, the glass particles or glass ceramic particles function not only as an “add on” functionality to increase the thermal stability, but also crucially for setting the basic functionality, i.e. ensuring a suitable porosity.

The coating is in this case preferably applied as a suspension onto the substrate. This may be done for instance by printing, pressing on, pressing in, rolling, spreading, brushing, immersion, injection or pouring.

If compatible with the coating process, a suspension from the grinding process may be used directly in the case of wet coating. Alternatively, an already provided glass powder may also be redispersed. For cost reasons, it is preferable to use the grinding suspension; for storage and transport reasons the use of powders is preferred.

For better processability and storage stability of the suspensions, for example—when necessary—polycarboxylic acids or salts thereof, or alkali-free polyelectrolytes and alcohols, for example isopropanol in exemplary quantities of from 0.05 to 3%, expressed in terms of the solids content, are to be added. With a view to the further method steps, the addition of suspending agents is preferably to be avoided, in order to prevent predictable reactions with the other components of the coating suspension.

In order to ensure adhesion of the particles, suitable binders or adhesion promoters are to be added to the coating suspension as additives. These may be either organic or inorganic.

### c) Coating of Electrodes

As an alternative or in addition, particles may be applied onto the cathode and/or the anode. The aforementioned methods may essentially be used. If possible or necessary, the specific media, or slurries, or methods, used to produce anodes or cathodes may or must be used. Furthermore, the integration process may especially be regarded as one or more electrodes being brought into contact with the pore membrane solution—the latter consisting of glass particle clusters and optionally binders. This includes, for example, immersion, spraying or spreading. It is also conceivable to entirely avoid application of the particles onto the electrodes onto a separator part per se. In this case, the function of the separator is undertaken by the coatings on the electrodes.

d) Introduction of Particles into the Liquid Electrolyte

Another possibility is to introduce the particles into the liquid electrolyte. In this case, the particles are not spatially fixed or bound, but act as a loose distance-maintaining fill. The introduction may, according to the application, only be carried out as a powder unless the grinding has been carried out in a non-aqueous medium.

### 9. Integration Examples

a) Glass AB2 was melted in a Pt crucible system and made into ribbons by means of a rolling machine (2 water-cooled rollers).

The ribbons were converted into fine powder in a two-stage drying & wet grinding method. In this case, a dry grinding process was applied first (drum mill, Al₂O₃, 24 h), and the final grain fraction was achieved by a subsequent wet grinding process (agitator ball mill, ZrO₂, 5-10 hours depending on the fine fraction desired). The wet grinding was in this case carried out in an aqueous medium without addition of additives.

The grain distribution in the slurry at the end of the wet grinding process was as follows:

D1.5˜dmin=80 nm

### D50=350 nm

D99˜dmax=1000 nm

The resulting slurry was converted into a fine powder with approximately comparable properties by spray drying:

The glass powder grains were predominantly edged and had a laminar to thick prismatic habitus.

As preparation for the coating process, the powders were redispersed in water. The resulting suspension was stable over several days and, in the event of settling, could be homogenized again easily without forming a solid sediment. A suspending agent was therefore not added.

The corresponding material (for example glass) was combined in the ratio 1:1 or 1:2 with a suitable polymer binder (for example poly(lithium-4-styrene sulfonate)) and subsequently put into solution by means of a suitable solvent (for example N,N-dimethylacetamide+water). This coating solution was then applied onto a membrane produced by a drying process from CELGARD (Celgard 2400: 25 μm thickness, 41% porosity) by an immersion process with subsequent drying.

The coated membrane was subjected to a similar chemical stability test described above, but with the entire separator being aged rather than the powder. The degradation values are comparable in relation to one another with the values from the glass powder measurements, and a comparative test with similarly produced laboratory membranes, but with crystalline SiO₂ having a similar grain distribution curve instead of glass AB2, shows the significant improvement over the prior art. The glass used is therefore also significantly more advantageous than SiO₂ in the separator assembly.

b) In a second test, the glass powder from exemplary embodiment a) was no longer redispersed. Instead, the grinding slurry from the last phase of the fine grinding was used directly.

Furthermore, a nonwoven was used instead of a membrane. For example, a PO nonwoven from Freudenberg (FS2202-03) with a thickness of about 30 pm was used.

For comparison, a nonwoven with Al₂O₃ ceramic powder having similar grain distribution curve grain characteristics as the aforementioned glass was produced as a filler.

The two carriers showed comparable results in the chemical degradation test. Advantageously, however, with an essentially comparable porosity, coating thickness and quality for the glass-coated carrier, a surface density lower by 15-20% was measured in comparison with the carrier coated with Al₂O₃, carrier density 20 g/m² overall density (carrier+Al₂O₃) 39 g/m², overall density (carrier+glass X) 33 g/m², and weight saving approximately 15%.

### 10. Integration into an Accumulator Cell

The separator produced according to 9. a) or b) is integrated into an exemplary cell structure. The separator 22 is placed approximately according to the FIGURE between two current conductors 14, 16, of aluminum and sheet Cu, particle-coated with active media (anode: graphite, cathode LiCoO₂). Alternatively, endless strips of anode (graphite), cathode (LiCoO₂) and separator were rolled up and thereby formed into cylinders. The rolls, or stacks, were selectively placed into an aluminum or steel housing 18, or placed between laminating foils of plastic-coated aluminum. Before sealing by means of a lid (hard case), or final lamination (in the case of a cushion cell), the liquid electrolyte 20 is introduced, or drawn into the unit by applying a reduced pressure. Appropriate measures for internal interconnection of the stacks/rolls and contacting of the conductor terminals which are fed out (electrode feed-throughs 12) must be implemented before sealing. As an alternative to graphite, other active media known in the relevant literature are also possible (anode materials containing Sn, Si or Ti, and for example Li titanate; Li—Fe phosphates, Li-manganese phosphates or Li—Mn—Ni—Al oxides as cathode materials).

TABLE 1

| | | VB 1 | VB 2A | VB 2B | VB 3 | VB 4 | AB1 | AB2 | AB3 | AB4 | AB5 |
|---|---|---|---|---|---|---|---|---|---|---|---|
| Particle size | | n.d. | 10.0 | 1.2 | 1.0 | 6.5 | 6.6 | 0.4 | 10.7 | 2.1 | n.d. |
| Density | | ~0.9 | 2.20 | 2.20 | 3.94 | 4.02 | 2.72 | 2.73 | | 2.60 | 2.42 |
| [g/cm³] | | | | | | | | | | | |
| Composition | | | | | | | | | | | |
| [wt %] | | | | | | | | | | | |
| SiO₂ | | | 100 | 100 | | 2 | 50.09 | 55 | 68.98 | 66.2 | 67.59 |
| ZrO₂ | | | | | | | | | | 3.3 | 3.36 |
| Al₂O₃ | | | | | 100 | | 11.63 | 10 | 12.55 | 20 | 20.33 |
| B₂O₃ | | | | | | 36 | 13.18 | 10 | 12.55 | | |
| La₂O₃ | | | | | | 43 | | | | | |
| MgO | | | | | | | | | | 2.7 | 2.75 |
| BaO | | | | | | | 23.88 | 25 | | | |
| ZnO | | | | | | | | | | 1.8 | 1.83 |
| Li₂O | | | | | | | | | 5.91 | 3.9 | 4.15 |
| K₂O | | | | | | | 0.02 | | | 0.6 | |
| Ta₂O₃ | | | | | | | | | | 1 | |
| P₂O₃ | | | | | | | | | | | |
| CaO | | | | | | | | | | | |
| Na₂O | | | | | | | 0.1 | | | | |
| SrO | | | | | | | 0.24 | | | | |
| As₂O₃ | | | | | | | 0.31 | | | | |
| Remainder | | n.d. | | | | 19 | n.d. | | n.d. | | n.d. |
| Conductivity | Normalized | | 8.4 | 12.1 | 8.1 | 8.4 | | 11.4 | | 9.3 | |
| [mS/cm] | conductivity | | | | | | | | | | |
| normalized to | Relative | | 975 | 800 | 8 | 76 | n.d. | 5 | n.d. | <1 | n.d. |
| equal volume | aging | | | | | | | | | | |
| of electrolyte, | 3 d [%] | | | | | | | | | | |
| after 1 or 3 days | | | | | | | | | | | |

TABL3 2

| | | AB6 | AB7 | AB8 | AB9 | AB10 |
|---|---|---|---|---|---|---|
| Particle size | | 5.6 | 9.2 | 2.7 | 10.4 | 12.0 |
| Density [g/cm³] | | 2.59 | 2.52 | 2.84 | 2.39 | 3.69 |
| Composition | | | | | | |
| SiO₂ | | | | 1.31 | | |
| Al₂O₃ | | 9.06 | 9.78 | 3.39 | 0.94 | 13.30 |
| B₂O₃ | | 4.03 | 4.39 | 0.98 | 3.08 | |
| P₂O₃ | | 70.39 | 76.70 | 69.88 | 79.50 | 11.60 |
| MgO | | 4.53 | 4.94 | 0.97 | | 2.70 |
| CaO | | | | 3.75 | | 7.90 |
| BaO | | | | 9.87 | | 16.60 |
| ZnO | | | | 5.95 | | |
| Li₂O | | | 3.89 | | 15.82 | |
| Na₂O | | | | 0.26 | | |
| K₂O | | 11.68 | | 1.86 | | |
| SrO | | | | | | 18.20 |
| F | | | | | | 30.10 |
| Conductivity | Normalized | 5.8 | 7.1 | n.d. | 6.1 | 3.4 |
| [mS/cm] | conductivity | | | | | |
| normalized to | | | | | | |
| equal volume | | | | | | |
| of electrolyte | | | | | | |
| | Relative | 4 | 1 | n.d. | 1 | |
| | aging | | | | | |
| | 3 d [%] | | | | | |

n.d.: not determined

What is claimed is:

1. An electrochemical energy accumulator, comprising:
a housing;
two electrodes arranged within said housing and being electrically accessible from outside;
a liquid electrolyte enclosed within said housing; and
a separator arranged within said electrolyte for separating said two electrodes from one another;
wherein said separator comprises a glass-based material comprising at least the following constituents (in wt.-% based on oxide):

| | |
|---|---|
| SiO₂ | 0-10 |
| Al₂O₃ | 0.5-20 |
| B₂O₃ | 0.5-7 |
| Li₂O | 0-20 |
| R₂O | <15 |
| RO | 0-22 |
| MgO | 0-7 |
| CaO | 0-10 |
| BaO | 0-20 |
| ZnO | 0-10 |
| P₂O₅ | 60-85 |
| F | 0-2 |

where R₂O is the total sodium oxide and potassium oxide content, and where RO is the total content of MgO, CaO, BaO, SrO and ZnO.

2. An electrochemical energy accumulator, comprising:
a housing;
two electrodes arranged within said housing and being electrically accessible from outside;
an electrolyte enclosed within said housing; and
a separator arranged within said electrolyte for separating said two electrodes from one another;
wherein said separator is made of a powdered glass-based material comprising at least the following constituents (in wt.-% based on oxide):

| | |
|---|---|
| SiO₂ + F + P₂O₅ | 20-95 |
| Al₂O₃ | 0.5-30 |
| BaO | >20; |

wherein said glass-based material has a density of less than 3.7 g/cm³.

3. The accumulator of claim 2, wherein said glass-based material is essentially free of titanium, germanium, and bismuth.

4. The accumulator of claim 2, wherein said glass-based material comprises at least the following constituents (in wt.-% based on oxide):

| | |
|---|---|
| SiO₂ | 50-95 |
| Al₂O₃ | 1-30 |
| B₂O₃ | 0-20 |
| Li₂O | 0-20 |
| R₂O | <15% |
| RO | >20-40 |
| MgO | 0-7 |
| CaO | 0-5 |
| BaO | >20-30 |
| SrO | 0-25 |
| ZrO₂ | 0-15 |
| ZnO | 0-5 |
| P₂O₅ | 0-10 |
| F | 0-2 |

fining agents in conventional amounts of up to 2%,
where R₂O is the total sodium oxide and potassium oxide content, and where RO is the total content of oxides of the type MgO, CaO, SrO, BaO, ZnO.

5. The accumulator of claim 2, wherein said glass-based material comprises at least the following constituents (in wt.-% based on oxide):

| | |
|---|---|
| SiO₂ | 0-10 |
| Al₂O₃ | 0.5-20 |
| B₂O₃ | 0-15 |
| R₂O | 0-25 |
| Li₂O | 0-20 |
| MgO | 0-10 |
| CaO | 0-10 |
| BaO | >20-25 |
| SrO | 0-25 |
| ZnO | 0-10 |
| P₂O₅ | >5-80 |
| F | 0-40 |

wherein R₂O is the total alkali metal oxide content.

6. The accumulator of claim 2, wherein said glass-based material comprises at least the following constituents (in wt.-% based on oxide):

| | |
|---|---|
| SiO₂ | 0-10 |
| Al₂O₃ | 0.5-20 |
| B₂O₃ | 0-7 |
| Li₂O | 0-20 |
| R₂O | <15 |
| RO | >20-22 |
| MgO | 0-7 |
| CaO | 0-10 |
| BaO | 0-20 |
| ZnO | 0-10 |
| P₂O₅ | 60-85 |
| F | 0-2 |

where R₂O is the total sodium oxide and potassium oxide content, and where RO is the total content of MgO, CaO, BaO, SrO and ZnO.

7. The accumulator of claim 5, wherein said glass-based material apart from random impurities, does not contain alkali metal oxides.

8. The accumulator of claim 5, wherein said glass-based material comprises 0 to 2 wt.-% of SiO₂.

9. The accumulator of claim 5, wherein said glass-based material comprises at least 0.5 wt.-% of magnesium oxide.

10. The accumulator of claim 5, wherein said glass-based material comprises at least 0.5 wt.-% of calcium oxide.

11. The accumulator of claim 5, wherein said glass-based material comprises at least 0.5 wt.-% of lithium oxide.

12. The accumulator of claim 5, wherein said glass-based material comprises at least 0.5 wt.-% of potassium oxide.

13. The accumulator of claim 2, wherein said glass-based material is configured as a powdered filler material within said electrolyte.

14. The accumulator of claim 2, further comprising a polymer-based separator onto which a coating made of said glass-based material is applied.

15. The accumulator of claim 2, further comprising a polymer-based separator which is infiltrated by said glass-based material.

16. The accumulator of claim 2, further comprising a self-supporting separator made of polymers compounded with said glass-based material.

17. The accumulator of claim 2, further comprising a self-supporting separator made of polymers compounded with said glass-based material and applied onto a support foil.

18. The accumulator of claim 2, wherein said separator is configured as a coating made of said powdered glass based material applied onto at least one of said two electrodes.

19. The accumulator of claim 2, wherein said glass based material is configured as a glass ceramic comprising precipitates selected from the group consisting of high quartz mixed crystals, keatite, eucryptite, cordierite crystals, and mixtures thereof.

20. A separator for use in an electrochemical energy accumulator, wherein said separator is made from a powdered glass-based material comprising at least the following constituents (in wt.-% based on oxide):

| | |
|---|---|
| SiO₂ + F + P₂O₅ | 20-95 |
| Al₂O₃ | 0.5-30 |
| BaO | >20; |

wherein said glass-based material has a density of less than 3.7 g/cm³.
